(19) United States
(12) Patent Application Publication
(10) Pub. No.: US 2024/0357285 A1
(43) Pub. Date: Oct. 24, 2024

(54) DISTRIBUTED MULTI-DEVICE AUDIO CAPTURE IN A SHARED ACOUSTIC ENVIRONMENT

(71) Applicant: Intel Corporation, Santa Clara, CA (US)

(72) Inventors: Adam Kupryjanow, Gdansk (PL); Jan Banas, Gdansk (PL); Pawel Trella, Gdansk (PL)

(73) Assignee: Intel Corporation, Santa Clara, CA (US)

(21) Appl. No.: 18/757,676

(22) Filed: Jun. 28, 2024

(51) Int. Cl. H04R 3/00; H04M 3/56; H04R 29/00

(52) U.S. Cl. CPC H04R 3/005; H04R 29/005; H04M 3/568

(57) ABSTRACT

Techniques are provided herein for auto-muting procedures that result in efficient high-quality audio capture in a multi-device environment. In particular, when there are multiple computing devices in a shared meeting room, the microphone with the highest rated audio input is selected for the teleconference audio input from the shared environment. Each computing device connected to the teleconference from the meeting room determines a score for its microphone signal. The score is shared with the other devices in the room, and the microphone signal with the highest score is transmitted to the conference. Host-based systems include a host device receiving and reviewing the scores and determining which microphones to auto-mute. Other distributed systems include each computing device transmitting its score to the other devices and receiving the scores from the other devices, and each device determining whether to auto-mute.

### TECHNICAL FIELD

This disclosure relates generally to audio in a shared acoustic environment, and in particular to enhancing voice call audio in a shared acoustic environment by using multi-device audio capture.

### BACKGROUND

Many people engage in meetings on computing devices, and hybrid meetings can include multiple users in a meeting room as well as one or more remote users on a teleconference or VoIP (Voice over Internet Protocol) call. In a corporate environment, each participant of a meeting may have their own computing device in front of them. When multiple computing devices having active microphones are connected to the same teleconference or VoIP call, all of the microphones on these devices can be in a listening mode at the same time while a user source talks. To prevent interference, meeting participants can manually mute and unmute their microphones as they wish to start or stop speaking. However, this process makes it difficult to maintain fluent conversations between users onsite and those connected remotely. It can become more difficult when the conference room is large and loudspeakers must be muted and unmuted together with the microphones. These processes can become cumbersome and can distract from the substance of the meeting.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG. 1 illustrates a deep learning system, in accordance with various embodiments.

FIGS. 2A-2C are high level block diagrams illustrating examples of distributed multi-deceive audio capture systems for multi-device environments, in accordance with various embodiments.

FIG. 3 is a block diagram illustrating an example of a distributed multi-deceive audio capture system for multi-device environments, in accordance with various embodiments.

FIGS. 4A-4B are block diagrams illustrating examples of distributed multi-device audio capture systems for multi-device environments in which the score for a microphone input is transmitted from a computing device, in accordance with various embodiments.

FIGS. 5A-5B are flow charts illustrating example methods for distributed multi-device audio capture systems for multi-device environments, in accordance with various embodiments.

FIG. 6 is a block diagram of an example computing device, in accordance with various embodiments.

### DETAILED DESCRIPTION

### Overview

With the increase of hybrid working models, there is a corresponding increase in hybrid meetings. During hybrid meetings, two or more people may be in a shared meeting room communicating with other meeting participants who are remotely joining the meeting. Generally, each person (including those in the shared meeting room) has their own computing device for joining and participating in the meeting. When multiple computing devices having active microphones are connected to the same teleconference or VoIP call, the microphones on the devices can cause interference if the microphones are in a listening mode at the same time. While meeting participants can manually mute and unmute their microphones as they wish to start or stop speaking, this process can become cumbersome and can distract from the substance of the meeting. Additionally, since manual muting and unmuting on each computing device is not synchronized, acoustic echo leakages across devices can occur, distracting from the meeting while the users coordinate. Selecting one microphone for the shared meeting room can result in variable audio quality, audio intelligibility, listening effort, and/or audio level for remote participants, since talkers who are further from the selected microphone can be difficult to hear. Headsets can be used to reduce echo leakages, between loudspeakers, but this can degrade user experience as a user's headset speakers will output the user's own voice captured by the selected microphone and delayed by the VoIP network. In some instances, dedicated hardware can be provided for multiple users in a single room, but these hardware systems are expensive and generally provide inferior audio signals as compared to microphones that are close to each speaker (e.g., in the speaker's computing device).

Techniques are provided herein for auto-muting procedures that result in efficient high-quality audio capture in a multi-device environment. In particular, systems and methods are provided herein to utilize the distributed microphone array provided by using the microphone in each computing device connected to a teleconference (e.g., an audio and/or video conference) from the shared acoustic environment. While in some implementations, the signal from each of the microphones in the shared environment can be aggregated on a single device for processing and transmitting to the teleconference, this can result in transmission of high amounts of data, degrading system efficiency. In some implementations, the audio input can be scored based on various factors, such as audio quality, intelligibility, listening effort, and/or level. The microphone from the shared acoustic environment (e.g., a shared meeting room) having the audio input with the highest score may be selected for the teleconference audio input from the shared environment.

In particular, in various implementations, each computing device connected to the teleconference in the shared acoustic environment determines a score for the microphone signal at the respective computing device. The score can be based on various factors, such as audio quality, intelligibility (e.g., speech intelligibility), listening effort, and/or level. The score is shared with one or more other devices, and the microphone signal with the highest score is transmitted to the teleconference. In some implementations, host-based systems and methods are provided for auto-muting the microphones except the microphone with the highest score, in which a host device receives and reviews the scores and determines which microphones to auto-mute. The host device can be one of the computing devices connected to the teleconference, or the host device can be a dedicated host device for the shared environment, such as a conference room host device. In some implementations, distributed systems and methods are provided in which each computing device transmits its score to the other devices in the shared environment and receives the scores from the other devices in the shared environment, and each computing device reviews the scores and determines whether to auto-mute. Thus, each computing device in the shared environment can auto-mute and auto-unmute itself based on its own score and the scores of the other devices in the shared environment. In various implementations, when a computing device auto-mutes its microphone, the computing device also mutes its loudspeaker(s). Similarly, when a computing device unmutes its microphone, the computing device also unmutes its loudspeaker(s).

While switching from one microphone to another microphone can be potentially disruptive and detected by a listener, the systems and methods discussed herein generally result a selected microphone providing a highly rated audio signal for each selected participant, such that a microphone switch tends to occur when a different participant begins to speak. Thus, any microphone switch may occur along with a switch in the participant who is speaking, minimizing or eliminating any potential disruption in the audio signal, and provided the audio signal with the highest score as the audio input from the shared meeting space for the meeting and/or teleconference.

According to various implementations, the computing devices connected to a teleconference determine a score for the local microphone input signal at a scoring module, which can be implemented as a neural network, such as a deep neural network (DNN). As described herein, a DNN layer may include one or more deep learning operations, such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor (also referred to as “output feature map (OFM)”) that includes one or more output activations (also referred to as “output elements”).

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN System

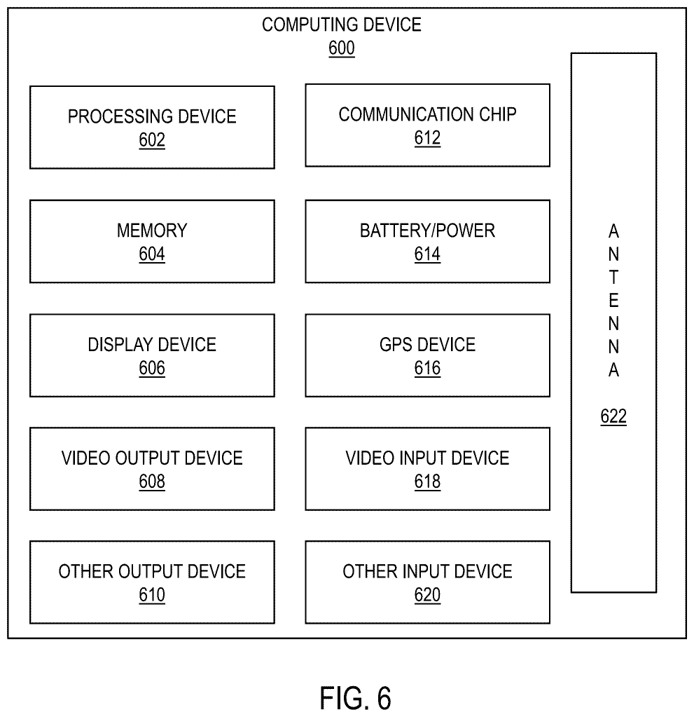

FIG. 1 is a block diagram of an example deep learning system 100, in accordance with various embodiments. In some examples, the deep learning system 100 is a deep neural network (DNN), and in some examples, the deep learning system 100 is a generative adversarial network (GAN). In some examples, the deep learning system 100 includes a subjectively-trained neural network. The deep learning system 100 trains DNNs for various tasks, including determining a score for an audio signal, which can be used, for example, to determine in real time a score for speech in an audio signal received at a microphone. In general, the scoring module 120 can be used for audio data, such as voice data. In various examples, the scoring module 120 can be trained to identify speech in the audio data and generate the score based on one or more qualities of the speech. The deep learning system 100 includes an interface module 110, a scoring module 120, a training module 130, a validation module 140, an inference module 150, and a datastore 160. In other embodiments, alternative configurations, different or additional components may be included in the deep learning system 100. Further, functionality attributed to a component of the deep learning system 100 may be accomplished by a different component included in the deep learning system 100 or a different system. The deep learning system 100 or a component of the deep learning system 100 (e.g., the training module 130 or inference module 150) may include the computing device 600 in FIG. 6.

The interface module 110 facilitates communications of the deep learning system 100 with other systems. As an example, the interface module 110 supports the deep learning system 100 to distribute trained DNNs to other systems, e.g., computing devices configured to apply DNNs to perform tasks such as scoring of an audio input signal. As another example, the interface module 110 establishes communications between the deep learning system 100 with an external database to receive data that can be used to train DNNs or input into DNNs to perform tasks. In some embodiments, data received by the interface module 110 may have a data structure, such as a matrix. In some embodiments, data received by the interface module 110 may be an audio clip, a sound bite, and/or an audio stream. In some examples, data received by the interface module 110 can extend to the non-audible spectrum, such as sound above or below a selected volume and/or frequency.

The scoring module 120 processes audio data received from a microphone. In some examples, the scoring module 120 identifies speech in a real time audio data stream. The audio data stream can be a sampled audio signal, and the scoring module may divide the audio signal samples into frames. The scoring module 120 can be implemented in firmware. In some examples, the scoring module 120 can convert the audio input using a short-time Fourier Transform (STFT) and perform feature extraction to provide feature vectors for input to the neural network. The scoring module 120 can include a subjectively-trained neural network, which may correspond with actual human listening experiences and perceptions of audio quality. In particular, a subjectively-trained neural network may be trained with datasets generated by using subjective reactions and/or ratings from one or more people.

The training module 130 trains DNNs by using training datasets. In some embodiments, a training dataset for training a DNN may include one or more of an audio clip, a sound bite, and/or an audio stream, each of which may be a training sample. The training module 130 may receive the audio data for processing with the scoring module 120 as described herein. In some examples, the scoring module 120 generates starting values for the model, and the training module 130 uses the starting values at the beginning of training. In some embodiments, the training module 130 may input different data into different layers of the DNN. For every subsequent DNN layer, the input data may be less than the previous DNN layer. The training module 130 may adjust internal parameters of the DNN to optimize scores for speech in the audio signal at the scoring module 120.

In some embodiments, a part of the training dataset may be used to initially train the DNN, and the rest of the training dataset may be held back as a validation subset used by the validation module 140 to validate performance of a trained DNN. The portion of the training dataset not including the tuning subset and the validation subset may be used to train the DNN. In some examples, the DNN uses data augmentation. Data augmentation is a method of increasing the training data by creating modified copies of the dataset, such as making minor changes to the dataset or using deep learning to generate new data points.

The training module 130 also determines hyperparameters for training the DNN. Hyperparameters are variables specifying the DNN training process. Hyperparameters are different from parameters inside the DNN (e.g., weights, biases). In some embodiments, hyperparameters include variables determining the architecture of the DNN, such as number of hidden layers, filters, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 10, 50, 100, or even larger.

The training module 130 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input audio data, such as input frequencies, input amplitudes, and various acoustic parameters for speech identification. The output layer includes labels for speech in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input audio data to a feature map that represents features of the audio data. A pooling layer can be used to reduce the spatial volume of input audio data after convolution. A pooling layer can be used between two convolution layers.

In the process of defining the architecture of the DNN, the training module 130 also uses a selected activation function for a hidden layer or the output layer. An activation function of a layer transforms the weighted sum of the input of the layer to an output of the layer. The activation function may be, for example, a rectified linear unit activation function, a tangent activation function, or other types of activation functions.

After the training module 130 receives the initial weights and biases for the DNN from the scoring module 120, the training module 130 inputs a training dataset into the DNN. The training dataset includes a plurality of training samples. An example of a training dataset includes an audio stream. An example of a training sample includes an audio signal including speech and a subjective rating for the speech in the audio signal. The audio signal can include one or more frames, and the frames may be overlapping. The training data is processed using the scoring module parameters of the DNN to produce a model-generated output, and updates the weights and biases to increase model output accuracy. The training module 130 modifies the parameters inside the DNN (“internal parameters of the DNN”) to minimize the error between scores as generated by the DNN and the ground-truth scores provided in the training dataset. The internal parameters include weights of filters in the convolutional layers of the DNN. In some embodiments, the training module 130 uses a cost function to minimize the error.

The training module 130 may train the DNN for a predetermined number of epochs. The number of epochs is a hyperparameter that defines the number of times that the deep learning algorithm will work through the entire training dataset. In some examples, when batch size equals one, one epoch means that each sample in the training dataset has had an opportunity to update internal parameters of the DNN. In some examples, the batch size is greater than one, and more samples are processed before parameters are updated. After the training module 130 finishes the predetermined number of epochs, the training module 130 may stop updating the parameters in the DNN. The DNN having the updated parameters is referred to as a trained DNN.

The validation module 140 verifies accuracy of trained DNNs. In some embodiments, the validation module 140 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 140 may determine an accuracy score measuring the precision, recall, or a combination of precision and recall of the DNN. The validation module 140 may use the following metrics to determine the accuracy score. In particular, the precision (P) can be how many the reference classification model correctly predicted (i.e., true positives (TP)) out of the total number it predicted (true positives plus false positives (FP)): Precision=TP/(TP+FP) Recall (R) may be how many the reference classification model correctly predicted (TP) out of the total number of objects that did have the property in question (TP+FN or false negatives): Recall=TP/(TP+FN),. The F-score (F-score=2*PR/(P+R)) unifies precision and recall into a single measure.

The validation module 140 may compare the accuracy score with a threshold score. In an example where the validation module 140 determines that the accuracy score of the augmented model is lower than the threshold score, the validation module 140 instructs the training module 130 to re-train the DNN. In one embodiment, the training module 130 may iteratively re-train the DNN until the occurrence of a stopping condition, such as the accuracy measurement indication that the DNN may be sufficiently accurate, or a number of training rounds having taken place.

The inference module 150 applies the trained or validated DNN to perform tasks. The inference module 150 may run inference processes of a trained or validated DNN. In some examples, inference makes use of the forward pass to produce model-generated output for unlabeled real-world data. For instance, the inference module 150 may input real-world data into the DNN and receive an output of the DNN. The output of the DNN may provide a solution to the task for which the DNN is trained for.

The inference module 150 may aggregate the outputs of the DNN to generate a final result of the inference process. In some embodiments, the inference module 150 may distribute the DNN to other systems, e.g., computing devices in communication with the deep learning system 100, for the other systems to apply the DNN to perform the tasks. The distribution of the DNN may be done through the interface module 110. The computing devices may be connected to the deep learning system 100 through a network. Examples of the computing devices include edge devices.

The datastore 160 stores data received, generated, used, or otherwise associated with the deep learning system 100. For example, the datastore 160 stores audio data processed by the scoring module 120 or used by the training module 130, validation module 140, and the inference module 150. The datastore 160 may also store other data generated by the training module 130 and validation module 140, such as the hyperparameters for training DNNs, internal parameters of trained DNNs (e.g., values of tunable parameters of activation functions, such as Fractional Adaptive Linear Units (FALUs)), etc. In the embodiment of FIG. 1, the datastore 160 is a component of the deep learning system 100. In other embodiments, the datastore 160 may be external to the deep learning system 100 and communicate with the deep learning system 100 through a network.

### Example Distributed Multi-Device Audio Capture Systems

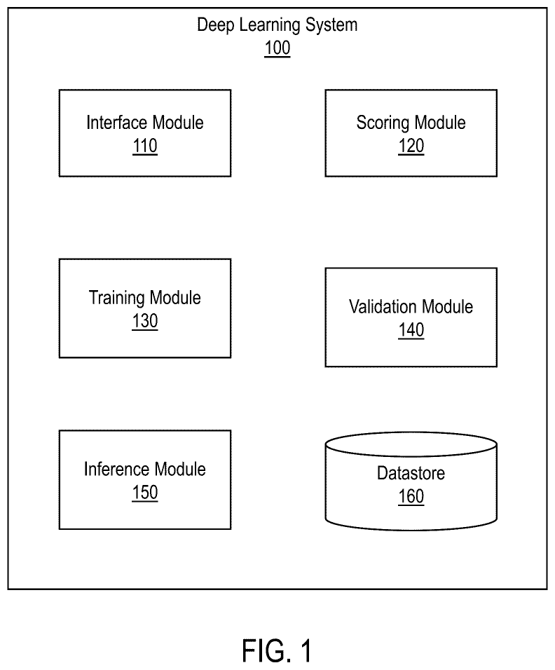

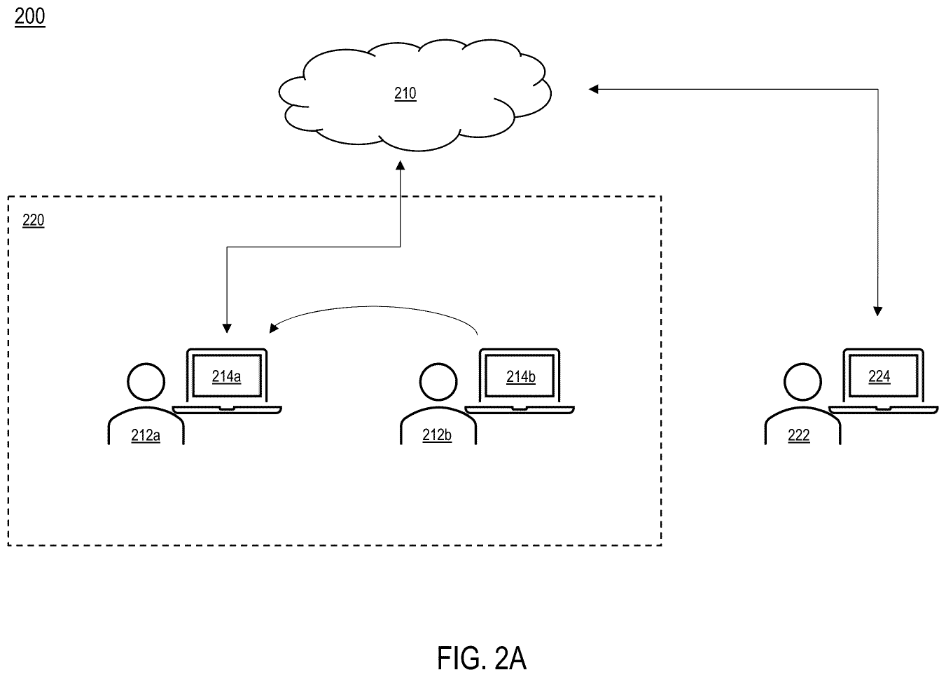

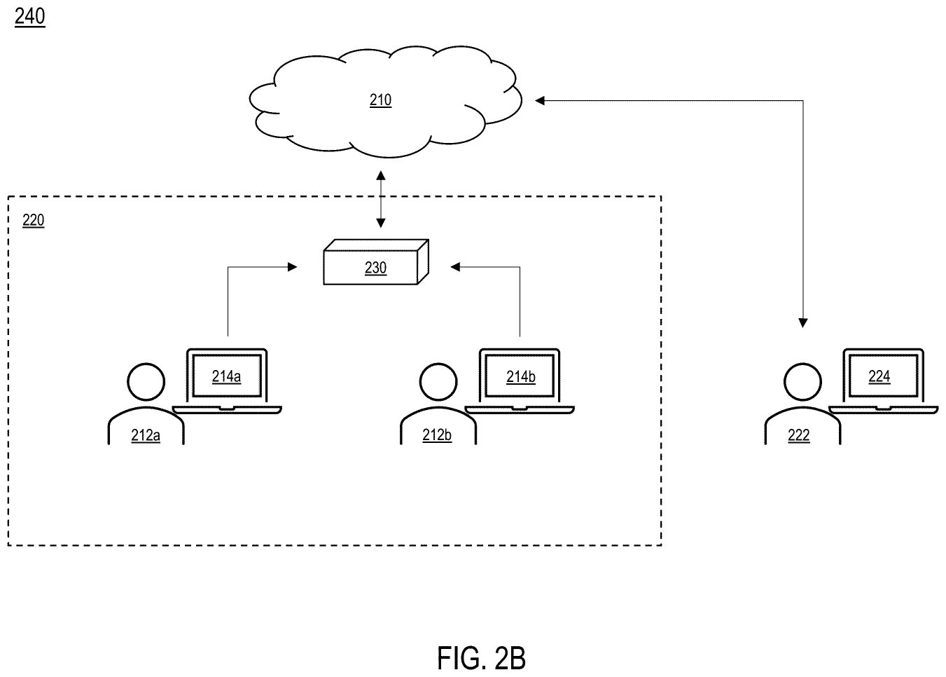

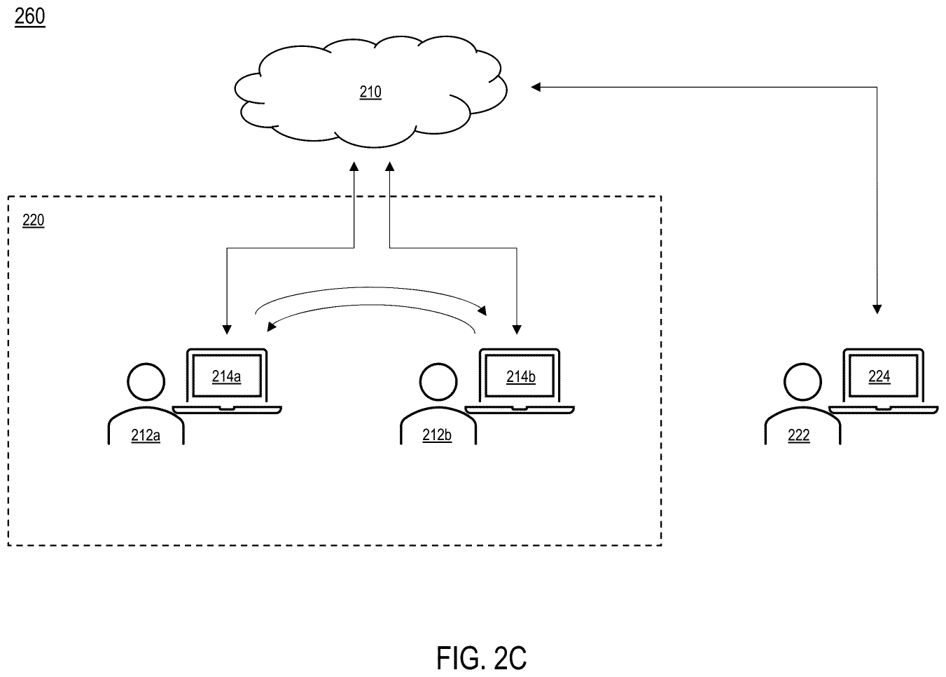

Systems and methods are presented herein for a distributed multi-deceive audio capture system that selects one of multiple devices for capturing audio input and mutes the unselected devices. FIGS. 2A-2C are high level block diagrams illustrating examples of distributed multi-deceive audio capture systems for multi-device environments, in accordance with various embodiments. In particular, the block diagrams of FIGS. 2A-2C illustrate a teleconference including three participants 212a, 212b, 222, each having a respective computing device 214a, 214b, 224, in which the first 212a and second 212b participants are in the shared acoustic environment 220, in accordance with various embodiments. The first 214a and second 214b computing devices and the remote computing device 224 are connected to the teleconference infrastructure 210, such that the participants 212a, 212b, 222 can take part in the teleconference on individual computing devices 214a, 214b, 224. If the microphones on each of the first 214a and second 214b computing devices are active, the audio signal transmitted from the shared acoustic environment 220 can include a lot of interference and be of poor quality. Additionally, if the loudspeakers on both the first 214a and second 214b computing devices are active, the speaker output can cause echo leakage and additional interference, further reducing the audio signal transmitted to the teleconference. Thus, systems and methods are provided to auto-mute one of the computing devices 214a, 214b such that both the microphone and loudspeaker from the selected computing device are muted. In some implementations, the shared acoustic environment 220 can include three or more computing devices 214, and all but one of the computing devices 214 will auto-mute. In some implementations, the computing devices 214 in the shared acoustic environment 220 auto-mute, and the computing device with the highest quality input signal unmutes.

The shared acoustic environment 220 can be a room such as a meeting room or a conference room. In various examples, the systems and methods described herein apply to computing devices in the shared acoustic environment 220 that are connected to the teleconference.

As shown in the illustrative example 200 of FIG. 2A, the first computing device 214a is a local host device for the shared acoustic environment 220. The first 214a and second 214b computing devices receive audio input from one or more audio sources in the shared acoustic environment 220 and each computing device 214a, 214b determines a score for the microphone input signal as received at its respective microphone. The score can include an audio quality metric, a speech quality metric ranking, an intelligibility metric (e.g., a speech intelligibility metric), a listener listening effort metric, and/or a level metric (e.g., an audio level, a speech level, etc.). The second computing device 214b can transmit its score to the local host device, which is the first computing device 214a. The first computing device 214a compares its own score with the scores from the second computing device 214b in the shared acoustic environment 220 and identifies the computing device with the highest score. The first computing device 214a instructs the computing device with the lower score to auto-mute its microphone.

When the shared acoustic environment 220 includes more than two computing devices participating in the teleconference, the computing devices transmit their scores to the local host device (i.e., the first computing device 214a), and the local host device compares all the scores, identifies the computing device with the highest score, and instructs the other computing devices to auto-mute their microphones. In some examples, the computing devices in the shared acoustic environment 220 auto-mute their microphones, and the local host device can instruct the computing device with the highest score to unmute its microphone. In some examples, the computing devices in the shared acoustic environment auto-mute their microphones while continuously monitoring the microphone input signal and generating a score, and the first computing device 214a can instruct a computing device currently transmitting its microphone signal to mute and simultaneously instruct a different computing device with a higher score to unmute.

As shown in the illustrative example 240 of FIG. 2B, the shared acoustic environment 220 includes a local host device 230. The first 214a and second 214b computing devices receive the audio input from one or more audio sources in the shared acoustic environment 220 and each computing device 214a, 214b determines a score for the microphone input signal as received at its respective microphone. The first 214a and second 214b computing devices both transmit their scores to the local host device 230. The local host device 230 compares the scores and identifies the computing device with the highest score. In some examples, the computing devices 214a, 214b in the shared acoustic environment 220 are auto-muted, and the local host device 230 sends an unmute instruction to the computing device with the higher score. In some examples, the local host device 230 sends a mute instruction to the computing device with the lower score. In some examples, the shared acoustic environment 220 includes three or more computing devices 214, and the local host device sends a mute instruction to all the computing devices except the computing device with the highest score.

As shown in the illustrative example 260 of FIG. 2C, the first 214a and second 214b computing devices in the shared acoustic environment 220 can communicate with each other. In particular, the first 214a and second 214b computing devices receive audio input from one or more audio sources in the shared acoustic environment 220, each computing device 214a, 214b determines a score for the microphone input signal as received at its respective microphone, and the first 214a and second 214b computing devices communicate their respective scores with each other. In one example, the first computing device 214a generates a first score, the second computing device 214b generates a second score, the first computing device 214a transmits its first score to the second computing device 214b, and the second computing device 214b transmits its second score to the first computing device 214b. The first computing device 214a compares the first and second scores and, if the first score is higher, the first computing device 214a unmutes its microphone; similarly, if the first score is lower, the first computing device 214a mutes its microphone. The second computing device 214b compares the first and second scores and, if the second score is higher, the second computing device 214b unmutes its microphone; similarly, if the second score is lower, the second computing device 214b mutes its microphone.

When the shared acoustic environment 220 includes more than two computing devices participating in the teleconference, the computing devices each transmit their scores to the other computing devices and receive scores from the other computing devices. Thus, in one example, there are three computing devices participating in the teleconference from the shared acoustic environment 220, each of the three computing devices receives scores from the other two computing devices, and compares its own score with the two received scores. When one of the received scores is higher than its own score, the computing device mutes its microphone, while if its own score is the highest score, the computing device unmutes its microphone. In some examples, the computing devices in the shared acoustic environment 220 auto-mute their microphones while continuously monitoring the microphone input signal, generating a score, and receiving scores from the other computing devices. In some examples, the computing devices in the shared acoustic environment 220 periodically generate and transmit a score, such as every 1 ms, 2 ms, 3 ms, 5 ms, 10 ms, or 50 ms. A computing device currently transmitting its microphone signal can auto-mute when it receives a higher score from a different computing device. Similarly, a computing device that is currently muted can auto-unmute when it receives scores that are that are lower than its score and determines it has the highest score.

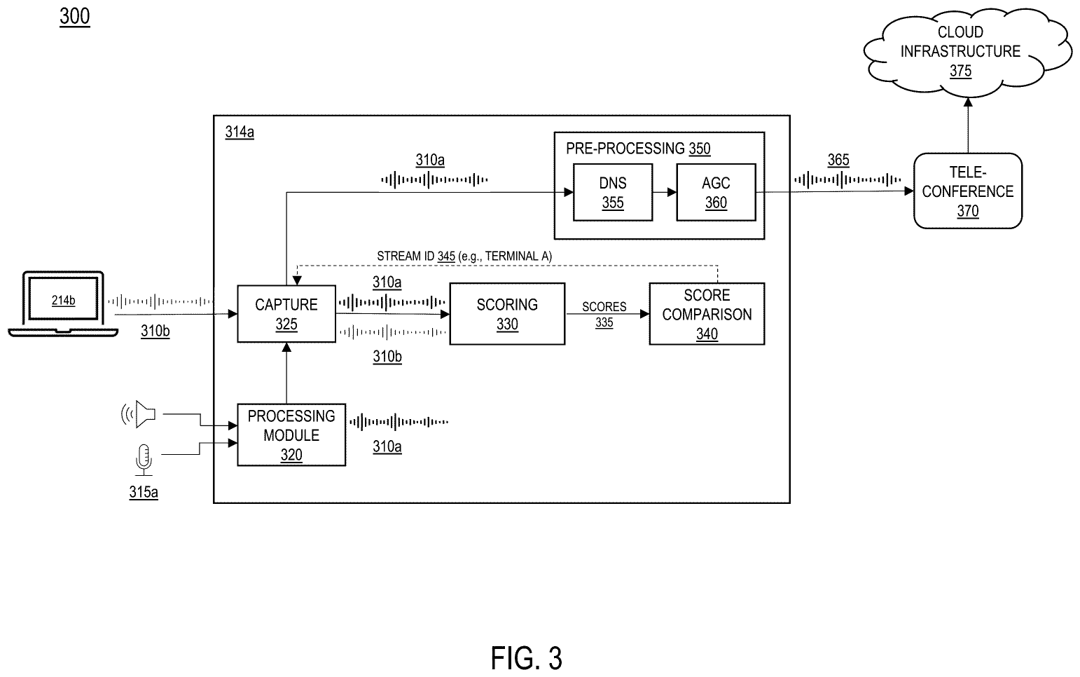

FIG. 3 is a block diagram illustrating an example of a distributed multi-deceive audio capture system 300 for multi-device environments, in which the local client terminals (i.e., the computing devices in the shared acoustic environment) receive audio input from one or more local audio sources and send their microphone input signals to the host device. In particular, as shown in FIG. 3, the second computing device 214b transmits its microphone input signal 310b to the host device, the first computing device 214a. The host device includes a microphone 315a that receives an audio input from the audio source(s) in the shared acoustic environment, and the host device processes the input at a processing module 320. The processing module 320 can perform pre-processing on the signal to remove noise and perform acoustic echo cancellation to remove echo from playback on the device. In various examples, playback is active on the computing device for which the microphone input is streamed to the teleconference.

The processed signal is the microphone input signal 310a for the host device. The host device includes a capture module 325 that receives the first 310a and second 310b microphone input signals. In various examples, when there are more than two computing devices in the shared acoustic environment that are connected to the teleconference, the capture module 325 receives the microphone input signals from any computing devices in the shared acoustic environment that have a microphone and are connected to the teleconference. The capture module 325 can include initial memory and storage units that may be used to intake the microphone signals. The microphone signals 310a, 310b can be transmitted from the capture module 325 to a scoring module 330.

The scoring module 330 can include a neural network and/or a deep learning system such as the deep learning system 100 described with respect to FIG. 1. In some examples, the scoring module 330 can include a combination of convolutional, ReLU, pooling, and fully connected layers with weights computed by training with a subjective training dataset as discussed herein. The scoring module 330 may divide each microphone input into frames, and one or more frames may be used by an input layer of the scoring module 330. In some examples, the scoring module 330 assesses each microphone input and provides a score 335 for each microphone input. The scores 335 are input to a score comparison module 340. In one example, the score for the first microphone input signal 310a is 4.5 while the score for the second microphone input signal 310b is 3.9.

The score comparison module 340 may read the scores 335 and compare the scores of the microphone input signals of the same sample time to each other to determine which audio signal has the best score and should be transmitted to the teleconference. The score of the best microphone input signal may be an initially selected input signal. In some examples, the highest score may be compared to a minimum score difference threshold to determine whether a microphone input switch should be performed. In some instances, no microphone switch will occur when the microphone input signal with the highest score cannot be differentiated from the currently selected microphone input signal by a person listening to the audio. The minimum score difference threshold may be stored in firmware, in main storage, or other memory, and may be a part of the score comparison module 340. In some examples, the score can be a number rating out of 5 or 10. In some instances, the score itself is only a few bits, for instance, the score can be eight bits or less than eight bits.

The score comparison module 340 outputs a stream identification 345 for the microphone input signal 310a, 310b with the highest score. In the example in which the score for the first microphone input signal 310a is 4.5 out of 5, while the score for the second microphone input signal 310b is 3.9 out of 5, the score comparison module 340 outputs a stream identification 345 to the capture module 325 indicating that the first microphone input signal 310a is to be transmitted to the teleconference.

The capture module 325 transmits the first microphone signal 310a to a pre-processing module 350. The pre-processing module 350 can include a dynamic noise suppression module 355 and an automatic gain control module 360. The dynamic noise suppression module 355 can remove noise from the first microphone signal 310a. The automatic gain control module 360 can normalize the amplitude of the signal to help generate a smooth switch between the current audio signal and the new best microphone input signal. In general, the switch from one microphone to another can be smoother with automatic gain control because it minimizes abrupt level changes from one microphone to another microphone. Normalization can generate audio signal characteristics closer to a generic or average signal. By one form, typical normalization may be used on the selected microphone input signal. By other forms, a neural network arrangement may be used (such as, for example, by using a cycle generative adversarial network (cycleGAN)) to provide a more normalized or generic audio signal that reduces the differences in microphone characteristics for input signals from the multiple microphones. The pre-processing module 350 outputs a pre-processed audio signal.

The pre-processed audio signal can be transmitted via the loudspeakers of the host device, or an audio transmission unit may encode and transmit the audio to a remote output device or audio emitter, which may be a remote device with an audio system and speakers. Whether or not remote, the audio emitter or output unit may have one or more loudspeakers to emit the audio. Instead, or in addition, an audio application unit, which can be local or remote on a different remote device, may receive one or more of the audio signals with the best (or better) score(s) to perform audio processing applications such as ASR, SR, AoA detection, specialized audio signal enhancement, and so forth. The pre-processed audio signal is transmitted to the teleconference 370, which may be local VoIP software. In some examples, the audio signal is transmitted to a cloud infrastructure 375, such as a VoIP infrastructure, and the audio signal can be transmitted from the VoIP infrastructure to remote participants in the meeting. In this manner, remote participants in the teleconference receive the audio signal from the host device.

In various examples, the system 300 includes transparent communication between the audio and Wi-Fi digital signal processors in the operating system of the host device, to enable Wi-Fi-based audio capture. Additionally, the compute power used by the host device increases with the number of local computing devices in the shared acoustic environment, since each local computing device transmits its microphone input to the host device, and the host device computes the score for each microphone input stream individually. Thus, the compute power of the host device can be a limitation of the number of devices that can connect to the host device and the multi-device audio capture system. Similarly, Wi-Fi bandwidth can be a limitation on the number of devices that can be connected to the host device and the multi-device audio capture system. Furthermore, when the host device is one of the local computing devices connected to the teleconference, it can be difficult for the participant who is the owner of the host device to leave the conference room before the end of the teleconference. Having a dedicated host device permanently located in the conference room can be an unnecessary cost.

In some aspects, distributed multi-device audio capture systems for shared acoustic environments are provided that resolve bandwidth issues and efficiently allow for an essentially unlimited number of local devices to join a teleconference while keeping costs low. In particular, the distributed multi-device audio capture systems and methods are provided in which scores are transmitted from each local computing device rather than audio signals being transmitted.

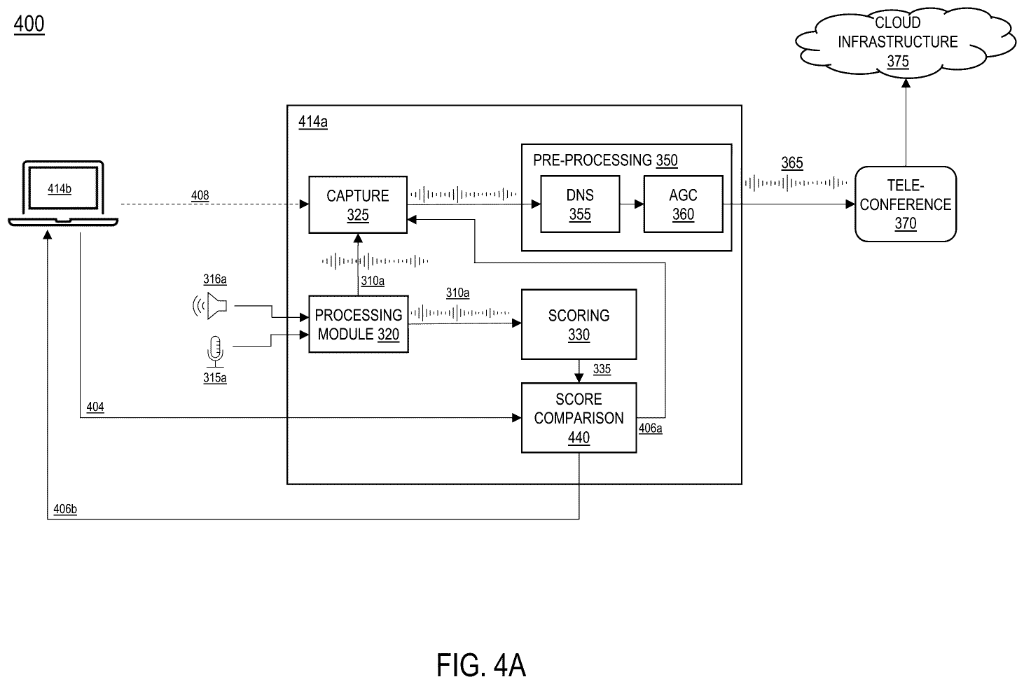

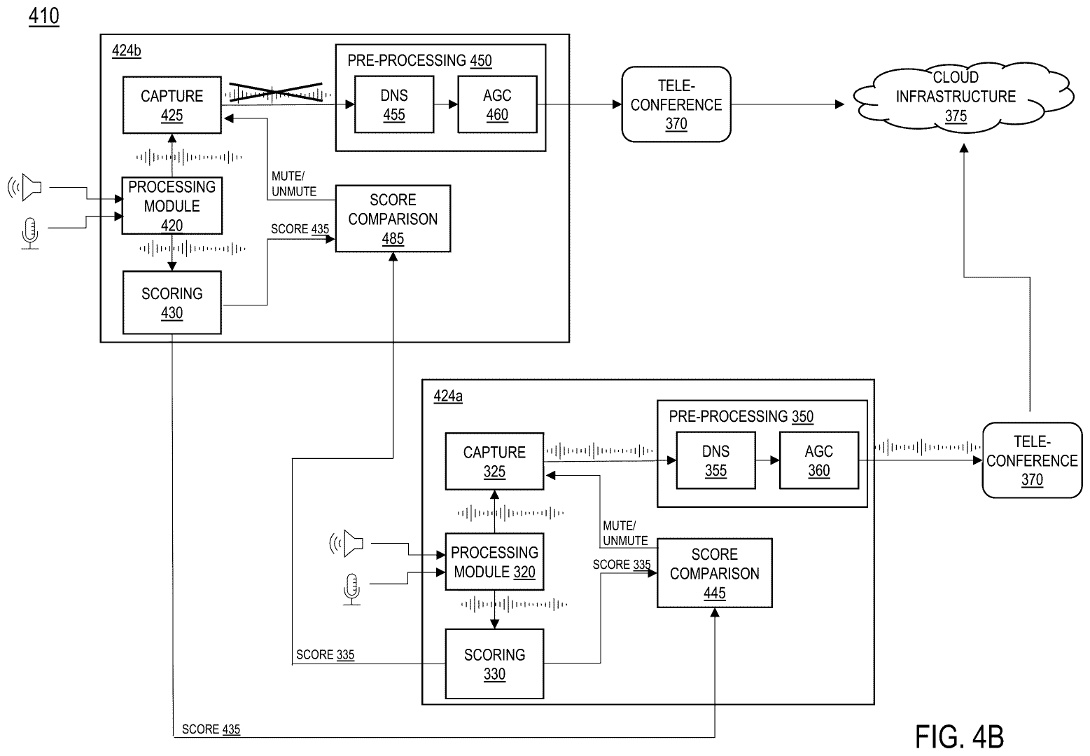

FIGS. 4A-4B are block diagrams illustrating examples of distributed multi-device audio capture systems for multi-device environments in which the score for a microphone input is transmitted from a computing device, in accordance with various embodiments. In particular, each computing device in the shared acoustic environment that is connected to the teleconference transmits a score for its microphone input, rather than transmitting the microphone input signal itself.

FIG. 4A is a block diagram illustrating an example of a distributed multi-device audio capture system 400 having a host computing device 414a and a local computing device 414b. The host device 414a is substantially similar to the host device 214a of FIG. 2A, the host device 230 of FIG. 2B, and/or the host device 314a of FIG. 3. The host device includes a microphone 315a that receives an audio input from the audio source(s) in the shared acoustic environment, and the host device 414a processes the microphone audio input at a processing module 320. The host device can also be the device that emits audio output from the teleconference, via the loudspeaker 316a. The processing module 320 can perform pre-processing on the signal to remove noise and perform acoustic echo cancellation to remove echo from playback from loudspeakers 316a on the device 414a.

The processed microphone signal 310a can be transmitted from the processing module 320 to a scoring module 330. The scoring module 330 can include a neural network and/or a deep learning system such as the deep learning system 100 described with respect to FIG. 1. In some examples, the scoring module 330 can include a combination of convolutional, ReLU, pooling, and fully connected layers with weights computed by training with a subjective training dataset as discussed herein. The scoring module 330 assesses the input signal 310a and provides a local score 335 for the processed microphone input signal 310a as described above. The local score 335 is input to a score comparison module 440. The score comparison module 440 also receives a received score 404 from the second computing device 414b. The second computing device 414b includes a microphone, processing module, and scoring module that are substantially the same as those of the host computing device 414a. The score comparison module 440 compares the local score 335 with the received score 404 from the second computing device 414b, and identifies the highest score. In some examples, when the local score 335 is the highest score, the score comparison module 440 outputs a message 406b instructing the second computing device 414b to mute its microphone. In some examples, when the local score 335 is the highest score, the score comparison module 440 outputs a message 406a instructing the host computing device 414a to unmute its microphone. In some examples, when the received score 406 is the highest score, the score comparison module 440 outputs a message 406b instructing the second computing device 414b to unmute its microphone. In some examples, when the received score 335 is the highest score, the score comparison module 440 outputs a message 406a instructing the host computing device 414a to mute its microphone.

As shown in the block diagram of the host computing device 414a, the message 406a from the score comparison module 440 is input to a capture module 325. The capture module 325 receives the processed audio signal 310a from the processing module 320. When the second computing device 414b receives a message 406b instructing the second computing device 414b to unmute its microphone, the second computing device 414b transmits its microphone input signal 408 to the capture module 325 on the host computing device 414a. The capture module 325 receives a message 406a from the score comparison module 440, and processes the received audio input signal with the highest score. In various embodiments, the capture module 325 receives an input signal from another computing device (e.g., the second computing device 414b) only when the other computing device has the highest score. In some examples, when the local score 335 is higher than the received score 404, the score comparison module 440 transmits an audio transmit instruction to the capture module 325, instructing the capture module 325 to transmit the local microphone audio signal 310a output from the processing module 320. When the received score 404 is higher than the local score 335, the score comparison module 440 transmits an audio transmit instruction to the capture module 325, instructing the capture module 325 to transmit the received microphone audio signal 408 from the local computing device 414b output from the processing module 320. In some examples, when the received score 404 is higher than the local score 335, and capture module 325 receives an instruction to transmit the received microphone audio signal 408, the capture module 325 discards the received local microphone input signal 310a.

The host computing device 414a processes the selected input signal at the pre-processing module 350 as described above with respect to FIG. 3, and outputs a processed audio signal 365 to the teleconference 370.

FIG. 4B is a block diagram illustrating an example of a distributed multi-device audio capture system 410 having multiple local computing devices, including a first local computing device 424a and a second local computing device 414b. The first local computing device 424a is substantially similar to the host device 214a of FIG. 2A, the host device 230 of FIG. 2B, the host device 314a of FIG. 3, and the host device 414a of FIG. 4A. The distributed multi-device audio capture system 410 includes only local computing devices with no host device. Each of the local computing devices 424a, 424b includes a microphone that receives an audio input from the audio source(s) in the shared acoustic environment. The local computing devices 424a, 424b process the microphone audio input at respective processing modules 320, 420. The processing modules 320, 420 can perform pre-processing on the respective received signals to remove noise and perform acoustic echo cancellation to remove echo from playback from loudspeakers on the respective devices 424a, 424b.

The processed microphone signals from the respective processing modules 320, 420 can be transmitted from the respective processing modules 320, 420 to respective scoring modules 330, 430 on each of the computing devices 424a, 424b. The scoring modules 330, 430 can include a neural network and/or a deep learning system such as the deep learning system 100 described with respect to FIG. 1. In some examples, the scoring modules 330, 430 can include a combination of convolutional, ReLU, pooling, and fully connected layers with weights computed by training with a subjective training dataset as discussed herein. The scoring modules 330, 430 assess the respective input signals and provide local scores 335, 435 for the processed microphone input signals as described above.

The local respective scores 335, 435 are input to respective score comparison modules 440, 485 on each device 424a, 424b. The first score comparison module 440 also receives a received score 435 from the scoring module 430 on the second computing device 414b. Similarly, the second score comparison module 485 also receives a received score 335 from the scoring module 330 on the first computing device 414a.

The first score comparison module 440 compares the local score 335 with the received score 435 from the second computing device 414b, and identifies the highest score. The second score comparison module 485 compares the local score 435 with the received score 335 from the first computing device 414a, and identifies the highest score.

In some examples, when the first score 335 is the highest score, the first score comparison module 445 outputs a message instructing the capture module 425 to unmute the second computing device 424b microphone. In some examples, when the second score 435 is the not the highest score, the second score comparison module 485 outputs a message instructing the capture module 425 to mute the second computing device 424b microphone.

In various embodiments, FIG. 4B shows an example in which the input signal at the first computing device 424a has a higher score 335 than the score 435 of the input signal at the second computing device 424b. Thus, the capture module 325 on the first computing device 424a receives an unmute message from the score comparison module 445 on the first computing device 424a and transmits the signal from the processing module 320 to the pre-processing module 350. In contrast, the capture module 425 on the second computing device 424b receives a mute message from the score comparison module 485 on the second computing device 424b and the capture module 425 does not transmit a signal to the pre-processing module 450. Thus, only one of the local computing devices 424a, 424b outputs an audio output signal to the teleconference 370, and in particular, in the embodiment shown in FIG. 4B, only the first local computing device 424a outputs an audio output signal to the teleconference 370.

In the distributed multi-device audio capture system 410 of FIG. 4B, the teleconference software, for example, VoIP software, is running on the local computing devices 424a, 424b connected to the teleconference from the shared acoustic environment. Audio signals are not transmitted between the local computing devices 424a, 424b and instead scores are shared between the local computing devices 424a, 424b. Based on the shared scores, each local computing device 424a, 424b determines whether to mute (or unmute) its microphone and loudspeakers. In particular, each local computing device 424a, 424b determines whether its score is the highest, and if its score is the highest, it unmutes its microphone and loudspeakers.

In various examples, the score determination can be performed on a firmware level and transferred to software, where a dedicated application can mute or unmute a computing device's audio endpoints (microphone and loudspeakers) on an operating system level. In various examples, each local computing device can be connected over a wireless network (e.g., Wi-fi) with other local computing devices present in the same room to form a wireless network of audio systems, and the scores from each local computing device in the wireless network of audio systems can be shared with the other local computing devices in the wireless network of audio systems. In some embodiments, the audio processing can be performed entirely on a firmware level and the scores can be shared with other local computing devices on a firmware level, e.g., through ultrasound signals.

### Example Method for Distributed Multi-Device Audio Capture

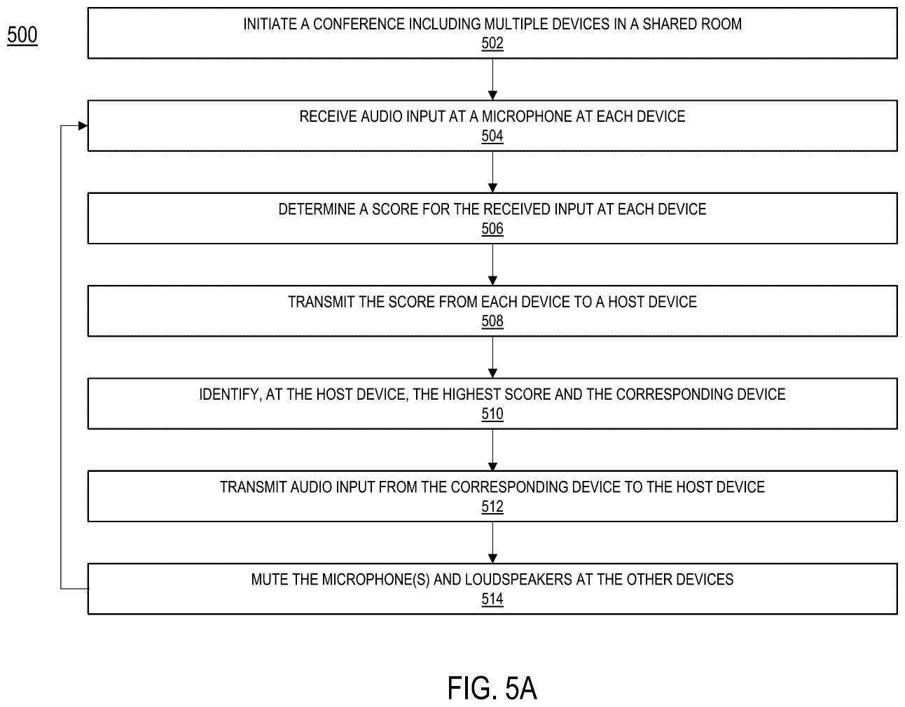

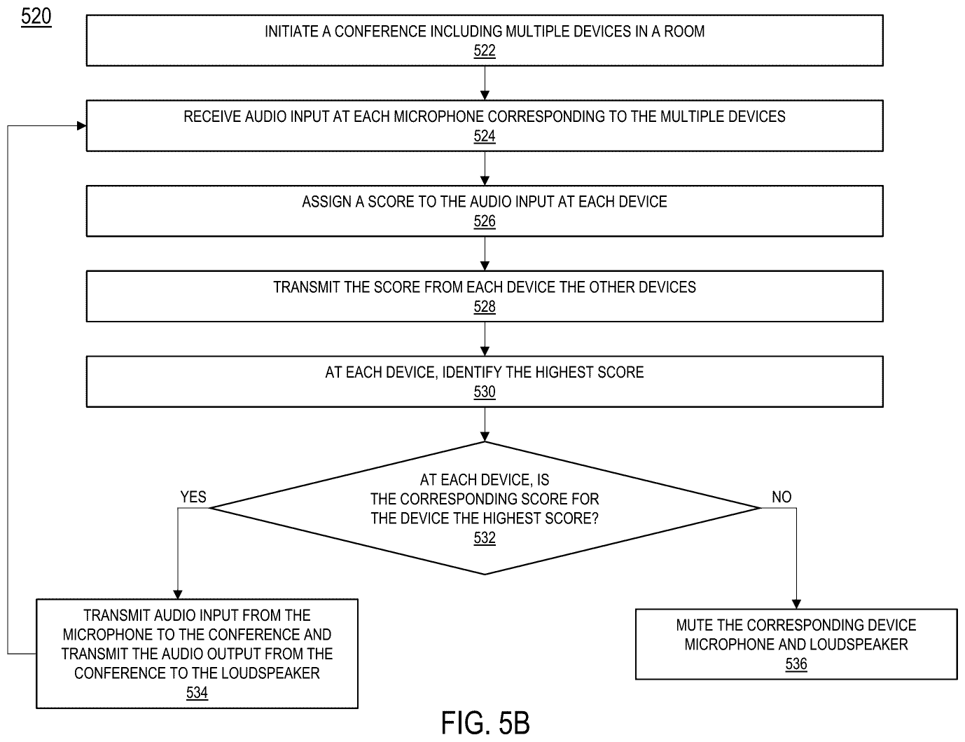

FIG. 5A is a flow chart illustrating an example method 500 for distributed multi-device audio capture, in accordance with various embodiments. At step 502, a conference including multiple devices is initiated. In some examples, the conference is a meeting including multiple devices in a shared room. In some examples, the conference is a teleconference. In some examples, the conference is a hybrid teleconference. A hybrid teleconference may include at least one remote device corresponding to a remote participant, and two local computing devices corresponding to two local participants, where the two local computing devices (and participants) are in the same meeting room and thus in a shared acoustic environment. At step 504, audio input is received at microphones at each of the local computing devices in the shared acoustic environment. For example, one of the local participants may be speaking, and the speech is received at the microphones at each of the local computing devices. Thus, the participant who is speaking is the audio source for an input signal at each of the microphones.

At step 506, each computing device in the shared acoustic environment determines a score for the audio signal received at its respective microphone. In various examples, each computing device has a scoring module that can generate a score for speech in the respective audio signal. The scoring module can be a neural network or other deep learning system as described above with respect to FIG. 1. In some examples, the scoring module can determine a score corresponding to a subjective speech quality in the respective audio signal.

At step 508, each computing device transmits its respective score to a host device. In some examples, the host device is one of the computing devices connected to the conference. In some examples, the host device is a dedicated host device that is present in the meeting room.

At step 510, the host device identifies the highest score of the respective scores received from each of the computing devices as well as its own local score. In general, the computing device with the highest score will unmute its microphone and the computing devices with scores lower than the highest score will mute their microphones (and loudspeakers). In some examples, the loudspeaker for the local meeting room is the loudspeaker on the host device, and in some examples, the loudspeaker for the local meeting room is the loudspeaker on the local computing device with the highest score.

At step 512, the audio input from the device with the highest score is transmitted to the host device. In particular, the device with the highest score unmutes its microphone and transmits its audio input to the host device. The host device may process the received audio input signal and output the audio signal to the teleconference. At step 514, the microphones at the other local computing devices, for which the scores are lower than the highest score, are muted. In various examples, step 514 can occur simultaneously with step 512. In various examples the method 500 returns to step 504, and steps 504-514 are periodically repeated. For example, steps 504-514 can be repeated about every 5 ms, 10 ms, 20 ms, 25, ms, or 50 ms. Thus, when a different participant in the meeting room begins speaking, the microphone with the highest score can change, and the microphone that is unmuted can be automatically switched via the method 500.

FIG. 5B is a flow chart illustrating an example method 520 for distributed multi-device audio capture, in accordance with various embodiments. Steps 522, 524, and 526 are substantially similar to steps 502, 504, and 506, respectively, as described above. At step 522, a conference including multiple devices is initiated. In some examples, the conference is a hybrid teleconference. A hybrid teleconference may include at least one remote device corresponding to a remote participant, and two local computing devices corresponding to two local participants, where the two local computing devices (and participants) are in the same meeting room and thus in a shared acoustic environment. At step 524, audio input is received at microphones at each of the local computing devices. For example, one of the local participants may be speaking, and the speech is received at the microphones at each of the local computing devices. Thus, the participant who is speaking is the audio source for an input signal at each of the microphones.

At step 526, each computing device determines a score for the audio signal received at its respective microphone. In various examples, each computing device has a scoring module that can generate a score for speech in the respective audio signal. The scoring module can be a neural network or other deep learning system as described above with respect to FIG. 1.

At step 528, each computing device transmits its respective score to the other computing devices in the shared room participating in the teleconference. At step 530, each device identifies the highest score of the respective scores received from each of the other local computing devices as well as its own local score. At step 532, each device determines whether the highest score corresponds to its own local score. If the highest score corresponds to its own local score, the method 520 proceeds to step 534 and the local computing device unmutes its microphone and transmits its audio input from its microphone to the teleconference. Similarly, the local computing device transmits the audio output from the teleconference to its loudspeaker. If the local device determines at step 532 that the highest score is does not correspond with its local score (i.e., its local score is lower than the highest score), the method 520 proceeds to step 536, and the local computing device mutes its microphone and loudspeaker.

In general, the computing device with the highest score will unmute its microphone and the computing devices with scores lower than the highest score will mute their microphones (and loudspeakers). In some examples, the loudspeaker for the local meeting room is the loudspeaker on the local computing device with the highest score.

In various examples, step 532 can occur simultaneously at each local computing device. In various examples the method 520 returns to step 524, and steps 524-536 are periodically repeated. For example, steps 524-536 can be repeated about every 5 ms, 10 ms, 20 ms, 25, ms, or 50 ms. Thus, when a different participant in the meeting room begins speaking, the microphone with the highest score can change, and the microphone that is unmuted can be automatically switched via the method 520.

### Example Computing Device

FIG. 6 is a block diagram of an example computing device 600, in accordance with various embodiments. In some embodiments, the computing device 600 may be used for at least part of the deep learning system 100 in FIG. 1, as well as the systems of FIGS. 2A, 2B, 3, 4A, and 4B. A number of components are illustrated in FIG. 6 as included in the computing device 600, but any one or more of these components may be omitted or duplicated, as suitable for the application. In some embodiments, some or all of the components included in the computing device 600 may be attached to one or more motherboards. In some embodiments, some or all of these components are fabricated onto a single system on a chip (SoC) die. Additionally, in various embodiments, the computing device 600 may not include one or more of the components illustrated in FIG. 6, but the computing device 600 may include interface circuitry for coupling to the one or more components. For example, the computing device 600 may not include a display device 606, but may include display device interface circuitry (e.g., a connector and driver circuitry) to which a display device 606 may be coupled. In another set of examples, the computing device 600 may not include a video input device 618 or a video output device 608, but may include video input or output device interface circuitry (e.g., connectors and supporting circuitry) to which a video input device 618 or video output device 608 may be coupled.

The computing device 600 may include a processing device 602 (e.g., one or more processing devices). The processing device 602 processes electronic data from registers and/or memory to transform that electronic data into other electronic data that may be stored in registers and/or memory. The computing device 600 may include a memory 604, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 604 may include memory that shares a die with the processing device 602. In some embodiments, the memory 604 includes one or more non-transitory computer-readable media storing instructions executable for muting and/or unmuting a microphone and/or controlling computing device loudspeakers, e.g., the methods 500, 520 described above in conjunction with FIGS. 5A and 5B or some operations performed by the deep learning system 100 in FIG. 1. The instructions stored in the one or more non-transitory computer-readable media may be executed by the processing device 602.

In some embodiments, the computing device 600 may include a communication chip 612 (e.g., one or more communication chips). For example, the communication chip 612 may be configured for managing wireless communications for the transfer of data to and from the computing device 600. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 612 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 612 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 612 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 612 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 612 may operate in accordance with other wireless protocols in other embodiments. The computing device 600 may include an antenna 622 to facilitate wireless communications and/or to receive other wireless communications (such as AM or FM radio transmissions).

In some embodiments, the communication chip 612 may manage wired communications, such as electrical, optical, or any other suitable communication protocols (e.g., the Ethernet). As noted above, the communication chip 612 may include multiple communication chips. For instance, a first communication chip 612 may be dedicated to shorter-range wireless communications such as Wi-Fi or Bluetooth, and a second communication chip 612 may be dedicated to longer-range wireless communications such as global positioning system (GPS), EDGE, GPRS, CDMA, WiMAX, LTE, EV-DO, or others. In some embodiments, a first communication chip 612 may be dedicated to wireless communications, and a second communication chip 612 may be dedicated to wired communications.

The computing device 600 may include battery/power circuitry 614. The battery/power circuitry 614 may include one or more energy storage devices (e.g., batteries or capacitors) and/or circuitry for coupling components of the computing device 600 to an energy source separate from the computing device 600 (e.g., AC line power).

The computing device 600 may include a display device 606 (or corresponding interface circuitry, as discussed above). The display device 606 may include any visual indicators, such as a heads-up display, a computer monitor, a projector, a touchscreen display, a liquid crystal display (LCD), a light-emitting diode display, or a flat panel display, for example.

The computing device 600 may include a video output device 608 (or corresponding interface circuitry, as discussed above). The video output device 608 may include any device that generates an audible indicator, such as speakers, headsets, or earbuds, for example.

The computing device 600 may include a video input device 618 (or corresponding interface circuitry, as discussed above). The video input device 618 may include any device that generates a signal representative of a sound, such as microphones, microphone arrays, or digital instruments (e.g., instruments having a musical instrument digital interface (MIDI) output).

The computing device 600 may include a GPS device 616 (or corresponding interface circuitry, as discussed above). The GPS device 616 may be in communication with a satellite-based system and may receive a location of the computing device 600, as known in the art.

The computing device 600 may include another output device 610 (or corresponding interface circuitry, as discussed above). Examples of the other output device 610 may include a video codec, a video codec, a printer, a wired or wireless transmitter for providing information to other devices, or an additional storage device.

The computing device 600 may include another input device 620 (or corresponding interface circuitry, as discussed above). Examples of the other input device 620 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 600 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 600 may be any other electronic device that processes data.

### SELECTED EXAMPLES

Example 1 provides a computer-implemented method, including receiving, at each of a plurality of computing devices, a respective audio signal wherein each respective audio signal corresponds to audio emitted from a same audio source; generating, at each of the plurality of computing devices, a local score for the respective audio signal at each of the plurality of computing devices; receiving, at a first computing device of the plurality of computing devices, from each respective other computing device of the plurality of computing devices, the local score generated at the respective other computing device, wherein the first computing device receives at least one received score; identifying, at the first computing device, a highest score of the at least one received score and the respective local score at the first computing device, wherein the highest score corresponds to a selected audio signal; and utilizing the selected audio signal for input to a receiving end of a system.

Example 2 provides the computer-implemented method of example 1, where the first computing device is a host computing device, where the highest score corresponds with a second received score from a second computing device, and further including the host computing device receiving the selected audio signal from the second computing device.

Example 3 provides the computer-implemented method of example 2, where the host computing device mutes a microphone at the host computing device.

Example 4 provides the computer-implemented method of example 1, further including receiving, at a second computing device of the plurality of computing devices, from each of the plurality of computing devices, the local score for the respective audio signal at each of the plurality of computing devices, where the second computing device receives at least one other score.

Example 5 provides the computer-implemented method of example 4, further including identifying, at the second computing device, the highest score of the at least one other score and the local score for the respective audio signal at the second computing device, where the highest score corresponds to the selected audio signal.

Example 6 provides the computer-implemented method of example 5, where the highest score corresponds with the at least one other score, and further including the second computing device muting a second computing device microphone and speaker.

Example 7 provides the computer-implemented method of example 5, where the highest score corresponds with the local score for the respective audio signal at the second computing device, and further including the second computing device unmuting a second computing device microphone and speaker.

Example 8 provides the computer-implemented method of example 1, where utilizing the selected audio signal for input to a network includes transmitting the selected audio signal to a teleconference.

Example 9 provides one or more non-transitory computer-readable media storing instructions executable to perform operations, the operations including receiving, at each of a plurality of computing devices, a respective audio signal where each respective audio signal corresponds to audio emitted from a same audio source; receiving, at a first computing device of the plurality of computing devices, from each of the plurality of computing devices, a local score for the respective audio signal at each of the plurality of computing devices, where the first computing device receives at least one received score; identifying, at the first computing device, a highest score of the at least one received score and the local score for the respective audio signal at the first computing device, where the highest score corresponds to a selected audio signal; and utilizing the selected audio signal for input to a network.

Example 10 provides the one or more non-transitory computer-readable media of example 9, where the first computing device is a host computing device, where the highest score corresponds with a second received score from a second computing device, and the operations further including the host computing device receiving the selected audio signal from the second computing device.

Example 11 provides the one or more non-transitory computer-readable media of example 10, the operations further including where the host computing device mutes a microphone at the host computing device.

Example 12 provides the one or more non-transitory computer-readable media of example 9, the operations further including receiving, at a second computing device of the plurality of computing devices, from each of the plurality of computing devices, the local score for the respective audio signal at each of the plurality of computing devices, where the second computing device receives at least one other score.

Example 13 provides the one or more non-transitory computer-readable media of example 12, the operations further including identifying, at the second computing device, the highest score of the at least one other score and the local score for the respective audio signal at the second computing device, where the highest score corresponds to the selected audio signal.

Example 14 provides the one or more non-transitory computer-readable media of example 13, where the highest score corresponds with the at least one other score, and the operations further including the second computing device muting a second computing device microphone and speaker.

Example 15 provides the one or more non-transitory computer-readable media of example 13, where the highest score corresponds with the local score for the respective audio signal at the second computing device, and the operations further including the second computing device unmuting a second computing device microphone and speaker.

Example 16 provides an apparatus, including a computer processor for executing computer program instructions; and a non-transitory computer-readable memory storing computer program instructions executable by the computer processor to perform operations including receiving, at each of a plurality of computing devices, a respective audio signal where each respective audio signal corresponds to audio emitted from a same audio source; receiving, at a first computing device of the plurality of computing devices, from each of the plurality of computing devices, a local score for the respective audio signal at each of the plurality of computing devices, where the first computing device receives at least one received score; identifying, at the first computing device, a highest score of the at least one received score and the local score for the respective audio signal at the first computing device, where the highest score corresponds to a selected audio signal; and utilizing the selected audio signal for input to a network.

Example 17 provides the apparatus of example 16, the operations further including receiving, at a second computing device of the plurality of computing devices, from each of the plurality of computing devices, the local score for the respective audio signal at each of the plurality of computing devices, where the second computing device receives at least one other score.

Example 18 provides the apparatus of example 17, the operations further including identifying, at the second computing device, the highest score of the at least one other score and the local score for the respective audio signal at the second computing device, where the highest score corresponds to the selected audio signal.

Example 19 provides the apparatus of example 18, where the highest score corresponds with the at least one other score, and the operations further including the second computing device muting a second computing device microphone and speaker.

Example 20 provides the apparatus of example 18, where the highest score corresponds with the local score for the respective audio signal at the second computing device, and the operations further including the second computing device unmuting a second computing device microphone and speaker.

Example 21 provides a computer-implemented method, including receiving, at each of a plurality of computing devices, a respective audio signal where each respective audio signal corresponds to audio emitted from a same audio source; determining, by each of the plurality of computing devices, a local score for the respective audio signal; transmitting the local score for the respective audio signal from each of the plurality of computing devices to other computing devices of the plurality of computing devices, where each computing device receives at least one received score; identifying, at each computing device, a highest score of the at least one received score and the local score for the respective audio signal; and determining, at a selected computing device of the plurality of computing devices, that the at least one received score is the highest score and muting a microphone at the selected computing device.

Example 22 provides the computer-implemented method of example 21, further including muting a loudspeaker at the selected computing device.

Example 23 provides the computer-implemented method of example 21, where the selected computing device is a first computing device, and further including determining, at a second computing device of the plurality of computing devices, that the local score for the respective audio signal at the second computing device is the highest score and transmitting the respective audio signal to a teleconference.

Example 24 provides a computer-implemented method, including receiving an audio input at a first microphone of a first device in a teleconference and at a second microphone of a second device in the teleconference; assigning a first score to a first microphone input and a second score to a second microphone input; transmitting the first score to the second device; transmitting the second score to the first device; and identifying, at the first and second devices, a highest score.

Example 25 provides a computer-implemented method, including receiving a first audio input at a first microphone of a first device in a teleconference and a second audio input at a second microphone of a second device in the teleconference, where the first and second audio inputs are associated with audio emitted from a same audio source; assigning a first score to the first audio input and a second score to the second audio input using a neural network; identifying a highest score of the first and second scores; identifying a selected microphone of the first and second microphones corresponding to the highest score; and selecting the selected microphone for audio signal transmission.

Example 26 provides the computer-implemented method of any of the above claims, wherein utilizing the selected audio signal for input to the receiving end of the system includes transmitting the selected audio signal to at least one of a conference, a teleconference, and a network.

Example 27 provides the computer-implemented method of any of the above claims, wherein generating the local score for the respective audio signal includes generating the local score based on at least one of audio quality of the respective audio signal, intelligibility of the respective audio signal, listening effort rating of the respective audio signal, and level of the respective audio signal.

Example 28 provides the computer-implemented method of any of the above claims, wherein each computing device of the plurality of computing devices is autonomous.

Example 29 provides the computer-implemented method of any of the above claims, wherein each computing device of the plurality of computing devices can auto-mute its microphone, auto-mute its loudspeaker, auto-unmute its microphone, and/or auto-unmute its loudspeaker.

The following paragraphs provide various examples of the embodiments disclosed herein.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method, comprising:
receiving, at each of a plurality of computing devices, a respective audio signal wherein each respective audio signal corresponds to audio emitted from a same audio source;
generating, at each of the plurality of computing devices, a local score for the respective audio signal at each of the plurality of computing devices;
receiving, at a first computing device of the plurality of computing devices, from each respective other computing device of the plurality of computing devices, the local score generated at the respective other computing device, wherein the first computing device receives at least one received score;
identifying, at the first computing device, a highest score of the at least one received score and the respective local score at the first computing device, wherein the highest score corresponds to a selected audio signal; and
utilizing the selected audio signal for input to a receiving end of a system.

2. The computer-implemented method of claim 1, wherein the first computing device is a host computing device, wherein the highest score corresponds with a second received score from a second computing device, and further comprising the host computing device receiving the selected audio signal from the second computing device.

3. The computer-implemented method of claim 2, wherein the host computing device mutes a microphone at the host computing device.

4. The computer-implemented method of claim 1, further comprising receiving, at a second computing device of the plurality of computing devices, from each respective other computing device of the plurality of computing devices, the local score generated at the respective other computing device, wherein the second computing device receives at least one other score.

5. The computer-implemented method of claim 4, further comprising identifying, at the second computing device, the highest score.

6. The computer-implemented method of claim 5, wherein the highest score corresponds with the at least one other score, and further comprising the second computing device muting a second computing device microphone and loudspeaker.

7. The computer-implemented method of claim 5, wherein the highest score corresponds with the respective local score for the second computing device, and further comprising the second computing device unmuting a second computing device microphone and loudspeaker.

8. The computer-implemented method of claim 1, wherein utilizing the selected audio signal for input to the receiving end of the system includes transmitting the selected audio signal to at least one of a conference, a teleconference, and a network.

9. The computer-implemented method of claim 1, wherein generating the local score for the respective audio signal includes generating the local score based on at least one of audio quality of the respective audio signal, intelligibility of the respective audio signal, listening effort rating of the respective audio signal, and level of the respective audio signal.

10. One or more non-transitory computer-readable media storing instructions executable to perform operations, the operations comprising:
receiving, at each of a plurality of computing devices, a respective audio signal wherein each respective audio signal corresponds to audio emitted from a same audio source;
generating, at each of the plurality of computing devices, a local score for the respective audio signal at each of the plurality of computing devices;
receiving, at a first computing device of the plurality of computing devices, from each respective other computing device of the plurality of computing devices, the local score generated at the respective other computing device, wherein the first computing device receives at least one received score;
identifying, at the first computing device, a highest score of the at least one received score and the respective local score at the first computing device, wherein the highest score corresponds to a selected audio signal; and
utilizing the selected audio signal for input to a receiving end of a system.

11. The one or more non-transitory computer-readable media of claim 10, wherein the first computing device is a host computing device, wherein the highest score corresponds with a second received score from a second computing device, and the operations further comprising the host computing device receiving the selected audio signal from the second computing device.

12. The one or more non-transitory computer-readable media of claim 11, the operations further comprising muting, at the host computing device, a microphone at the host computing device.

13. The one or more non-transitory computer-readable media of claim 10, the operations further comprising receiving, at a second computing device of the plurality of computing devices, from each respective other computing device of the plurality of computing devices, the local score generated at the respective other computing device, wherein the second computing device receives at least one other score.

14. The one or more non-transitory computer-readable media of claim 13, the operations further comprising identifying, at the second computing device, the highest score.

15. The one or more non-transitory computer-readable media of claim 14, wherein the highest score corresponds with the at least one other score, and the operations further comprising the second computing device muting a second computing device microphone and loudspeaker.

16. The one or more non-transitory computer-readable media of claim 14, wherein the highest score corresponds with the local score for the second computing device, and the operations further comprising the second computing device unmuting a second computing device microphone and loudspeaker.

17. An apparatus, comprising:
a computer processor for executing computer program instructions; and
a non-transitory computer-readable memory storing computer program instructions executable by the computer processor to perform operations comprising:
receiving, at each of a plurality of computing devices, a respective audio signal wherein each respective audio signal corresponds to audio emitted from a same audio source;
generating, at each of the plurality of computing devices, a local score for the respective audio signal at each of the plurality of computing devices;
receiving, at a first computing device of the plurality of computing devices, from each respective other computing device of the plurality of computing devices, the local score generated at the respective other computing device, wherein the first computing device receives at least one received score;
identifying, at the first computing device, a highest score of the at least one received score and the respective local score at the first computing device, wherein the highest score corresponds to a selected audio signal; and
utilizing the selected audio signal for input to a receiving end of a system.

18. The apparatus of claim 17, the operations further comprising receiving, at a second computing device of the plurality of computing devices, from each respective other computing device of the plurality of computing devices, the local score for the respective other computing device, wherein the second computing device receives at least one other score.

19. The apparatus of claim 18, wherein the highest score corresponds with the at least one other score, and the operations further comprising the second computing device muting a second computing device microphone and loudspeaker.

20. The apparatus of claim 18, wherein the highest score corresponds with the local score for the second computing device, and the operations further comprising unmuting a second computing device microphone and loudspeaker.
